(19) United States
(12) Patent Application Publication
(10) Pub. No.: US 2025/0329242 A1
(43) Pub. Date: Oct. 23, 2025

(54) FIELD ARMABLE ENVIRONMENTAL SENSOR DEVICE

(71) Applicant: ShockWatch, Inc, Dallas, TX (US)

(72) Inventors: Anthony N. Fonk, Austin, TX (US); Johannes van Niekerk, Dallas, TX (US)

(21) Appl. No.: 19/179,087

(22) Filed: Apr. 15, 2025

Related U.S. Application Data
(60) Provisional application No. 63/635,141, filed on Apr. 17, 2024.
(60) Provisional application No. 63/651,577, filed on May 24, 2024.

(51) Int. Cl. G08B 21/18; G01K 11/06; G01P 1/00; H02J 50/00; H02J 50/20

(52) U.S. Cl. CPC G08B 21/182; G01K 11/06; G01P 1/06; H02J 50/001; H02J 50/20

(57) ABSTRACT

An environmental sensor device includes a detection assembly comprising at least one response component that is responsive to receipt by the detection assembly of an environmental stimuli exceeding a threshold. An arming assembly is configured to maintain the detection assembly in an unarmed state. The arming assembly includes a collecting element and a retention element coupled to the collecting element. The retention element is positioned to prevent the at least one response component from being responsive to the environmental stimuli. The collecting element is configured to collect energy that causes an ablation of the retention element to place the detection assembly in an armed state.

### CROSS-REFERENCE TO RELATED APPLICATIONS

This application claims the benefit of priority under 35 U.S.C. § 119(e) to U.S. Provisional Application No. 63/635,141, filed Apr. 17, 2024, and U.S. Provisional Application No. 63/651,577, filed May 24, 2024, the contents of each of which are hereby incorporated in their entireties.

### BACKGROUND

During manufacturing, storage or transit, many types of objects need to be monitored due to the sensitivity or fragility of the objects. For example, some types of objects may be susceptible to damage if dropped or a significant impact is received. Other types of objects need to be monitored or tracked due to the temperature sensitivity or fragility of the objects. For example, some types of objects may be susceptible to damage if exposed to certain temperatures (e.g., food or pharmaceutical items). Thus, for quality control purposes and/or the general monitoring of transportation conditions, it is desirable to determine and/or verify the environmental conditions to which the object has been exposed.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 is a schematic diagram illustrating an application of an embodiment of an environmental sensor device according to the present disclosure;

FIG. 2 is a is a block diagram illustrating an embodiment of an environmental sensor device according to the present disclosure;

FIG. 3 is a schematic diagram illustrating a portion of an embodiment of an environmental sensor device according to the present disclosure in an unarmed state;

FIG. 4 is a schematic diagram illustrating a portion of the embodiment of the environmental sensor device of FIG. 3 according to the present disclosure in an armed state;

FIG. 5 is a schematic diagram illustrating an embodiment of an environmental sensor device according to another embodiment of the present disclosure;

FIG. 6 is a schematic diagram illustrating a section view of a portion of the environmental sensor device of FIG. 5 in accordance with the present disclosure in an unarmed state; and

FIG. 7 is a schematic diagram illustrating a section view of the portion of the environmental sensor device of FIG. 5 in accordance with the present disclosure in an armed state.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The following description is provided to enable those skilled in the art to make and use the described embodiments contemplated for carrying out the disclosure. Various modifications, equivalents, variations, and alternatives, however, will remain readily apparent to those skilled in the art. Any and all such modifications, variations, equivalents, and alternatives are intended to fall within the scope of the present disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first” and “second” may be used interchangeably to distinguish one component from another and are not intended to signify location or importance of the individual components.

The singular forms “a”, “an”, and “the” include plural references unless the context clearly dictates otherwise.

The terms “coupled,” “fixed,” “attached to,” and the like refer to both direct coupling, fixing, or attaching, as well as indirect coupling, fixing, or attaching through one or more intermediate components or features, unless otherwise specified herein.

Embodiments of the present disclosure provide a device and technique for field arming a sensor device. As used herein, an “unarmed” state of the sensor device refers to a state that is non-reactive to an environmental stimulus that the sensor device is configured to detect and/or indicate, and an “armed” state of the sensor device refers to a state that is reactive to an environmental stimulus that the sensor device is configured to detect and/or indicate. In other words, in an unarmed state, the sensor device is configured to be maintained in an unactivated state even though the sensor device may experience an environmental stimulus the sensor device is configured to detect such as, by way of non-limiting example, a temperature event exceeding a threshold. Accordingly, in an armed state, the sensor device is configured to be responsive to an environmental stimulus exceeding a threshold to provide an indication that the environmental stimulus was experienced.

In exemplary embodiments, a device and technique for field arming an environmental sensor device does not require the removal of an element of the environmental sensor device by a user of the environmental sensor device to place the sensor device in an armed state. In other words, embodiments of the present disclosure enable a non-contact arming of the environmental sensor device. According to exemplary embodiments, an environmental sensor device includes an arming assembly having an energy collecting element configured to collect energy from radio wavers impinging upon the energy collecting element. The arming assembly is configured to generate a current from the collected energy such that the current generates thermal energy to ablate a portion of the arming assembly to arm the environmental sensor device. In exemplary embodiments, radio waves from a device such as, by way of non-limiting example, a radio frequency identification (RFID) reader device to generate the current flow and thermal energy. Thus, in exemplary embodiments, a non-contact method of arming the environmental sensor device is provided such that a user of the environmental sensor device is not required to physically remove a pull tab, pin, or other element of the environmental sensor device to arm the environmental sensor device.

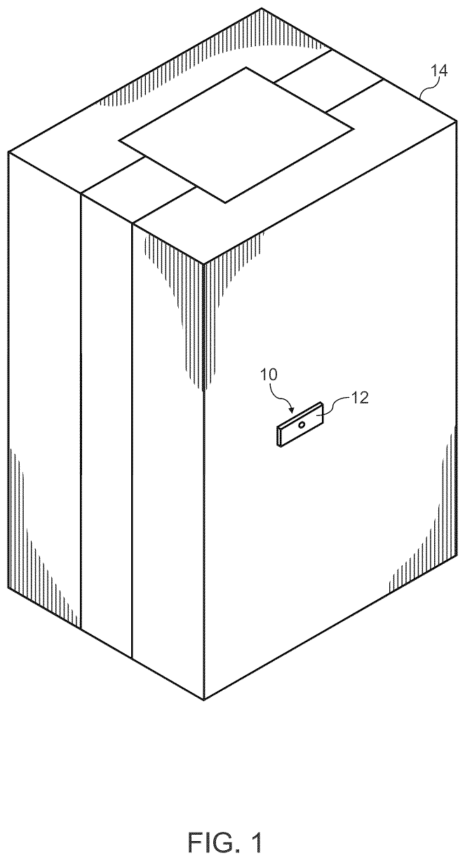

With reference now to the Figures and in particular with reference to FIG. 1, an exemplary diagram of a sensor device 10 is provided in which illustrative embodiments of the present disclosure may be implemented. In FIG. 1, the sensor device 10 is a portable device configured to be affixed to or disposed within a transport container 14 containing an object of which events associated therewith are to be monitored such as, by way of non-limiting example, temperature and/or impact events exceeding a defined time and/or threshold. Embodiments of sensor device 10 monitor whether an object has been exposed to some level of an environmental stimulus event during manufacturing, storage, use, and/or transport of the object. In some embodiments, the sensor device 10 may include a housing 12 that may be affixed to a transport container 14 using, for example, adhesive materials, permanent or temporary fasteners, or a variety of different types of attachment devices. The transport container 14 may include a container in which a monitored object is loosely placed or may comprise a container/surface of the monitored object itself. It should be appreciated that FIG. 1 is only exemplary and is not intended to assert or imply any limitation with regard to the environments in which different embodiments may be implemented.

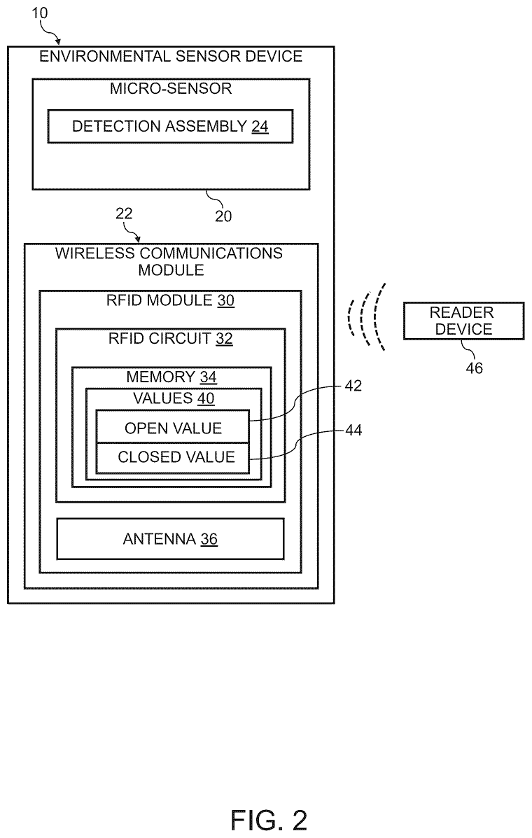

FIG. 2 is a block diagram representing and illustrating an embodiment of sensor device 10 in accordance with an embodiment of the present disclosure. In FIG. 2, within the housing 12 (FIG. 1), sensor device 10 includes a micro-sensor 20 and a wireless communications module 22. Micro-sensor 20 is a micro-mechanical and/or micro-electronic device (e.g., a microscopic device or system (e.g., generally having micrometer-sized components with an overall size generally measured in square millimeters)) for detecting an environmental event. Micro-sensor 20 may be configured as a microelectromechanical systems (MEMS) device (e.g., using silicon or other materials in the process or technique of deposition of material layers, patterning by photolithography, and etching to produce the required shape/components), a liquid crystal display (LCD) panel-fabricated device (e.g., a device manufactured using glass components and/or a glass substrate via LCD fabrication processes such as patterning, laminating, masking, cutting, and thin-film transistor (TFT) deposition techniques, which may or may not include liquid crystal), and/or be formed using roll-to-roll (R2R) processing techniques (e.g., creating the device on a roll of flexible plastic, metal foil, or flexible glass).

In some embodiments, micro-sensor 20 includes a detection assembly 24. Detection assembly 24 may comprise one or more switch elements, traces, contacts, circuits, fluids, absorbent materials, meltable substances, masses, and/or other types of structure and/or components configured to detect an environmental stimulus and/or detect a change in an activation status of the micro-sensor 20. For example, in some embodiments, the micro-sensor 20 may include a movable element that moves or becomes displaced in response to being subjected to an impact and/or temperature event. The displacement of the movable element may cause a state change in the detection assembly 24 (e.g., a change in impedance, changing from an open circuit condition to a closed circuit condition, or vice versa, etc.). Wireless communications module 22 is configured to wirelessly communicate information associated with a state of the detection assembly 24 indicating the activation state of the sensor device 10 (e.g., based on an open or closed circuit state of assembly 24). For example, in one embodiment, the wireless communications module 22 includes an RFID module 30. In some embodiments, the RFID module 30 includes a passive RFID module 30 (e.g., a passive RFID tag) having an RFID integrated circuit or circuitry 32 (e.g., disposed on or as part of a printed circuit board) and a memory 34, along with an antenna 36. As a passive RFID module 30, the sensor device 10 does not contain a battery (e.g., power is supplied by an external reader device 46 such as, by way of non-limiting example, a wireless or RFID reader), thereby forming a battery-free environmental sensor device 10. For example, in embodiments where the reader device 46 is an RFID reader device, when radio waves from the reader device 46 are encountered by the RFID module 30, the antenna 36 forms a magnetic field, thereby providing power to the RFID module 30 to energize the circuitry 32. Once energized/activated, the RFID module 30 may output/transmit information encoded in the memory 34. However, it should be understood that, in some embodiments, the RFID module 30 may comprise an active RFID module 30 including a power source (e.g., a battery) that may be configured to continuously, intermittently, and/or according to programmed or event triggers, broadcast or transmit certain information. One embodiment of a passive RFID tag is a flex circuit RFID in a roll form. In flex circuit RFIDs, the chip and antenna are embedded onto a thin substrate of 100 to 200 nanometers (nm) using, for example, polyvinyl chloride (PVC), polyethylenetherephtalate (PET), phenolics, polyesters, styrene, or paper via copper etching or hot stamping. One process for RFID manufacture is screen printing using conductive ink containing copper, nickel, or carbon. An example of a commercially available flex circuit passive RFID tag product that can come hundreds or even thousands in a roll is the Smartrac™ product from Avery Dennison Corporation.

It should also be understood that the wireless communications module 22 may be configured for other types of wireless communication types, modes, protocols, and/or formats (e.g., short-message services (SMS), wireless data using General Packet Radio Service (GPRS)/3G/4G or through public internet via Wi-Fi, or locally with other radio-communication protocol standards such as Wi-Fi, Z-Wave, ZigBcc, Bluetooth®, Bluetooth® low energy (BLE), LORA, NB-IoT, SigFox, Digital Enhanced Cordless Telecommunications (DECT), or other prevalent technologies). As will be described further below, in response to receipt of a particular level and/or magnitude of an environmental event, the environmental sensor device 10 functions as a passive sensor/indicator that can be used as part of an electronic signal or circuit. In some embodiments, the environmental sensing capabilities/functions of the environmental sensor device 10 of the present disclosure need no power while in the monitoring state.

In the illustrated embodiment, the memory 34 may include one or more stored and/or encoded values 40 that are externally and/or wirelessly communicated by the wireless communication module 22 to indicate whether (or not) the environmental sensor device 10 has been activated or, in other words, experienced or detected an environmental event that it is configured to detect. In exemplary embodiments, the one or more values 40 may include at least two different stored and/or encoded values 42 and 44. For example, value 42 may correspond to a value outputted/transmitted by the wireless communication module 30 when the detection assembly 24 is in an open circuit condition or state, and value 44 may correspond to a value outputted/transmitted by the wireless communication module 30 when detection assembly 24 is in a closed circuit condition or state. As an example, the value 44 may represent an RFID tag identification (ID) number not having an activated detection assembly 24, and the RFID tag's ID number may have an additional character (e.g., “0”) placed at the end thereof. The value 42 may represent the RFID ID number having an activated detection assembly 24, and the RFID tag's ID number may have an additional character at the end thereof being different from the additional character carried by the value 44 (e.g., “1”). In the illustrated embodiment, the RFID module 30 (e.g., the circuitry 32) is coupled to the detection assembly 24 and can detect whether the detection assembly 24 is in an open or closed circuit condition or state. Thus, for example, the detection assembly 24 may initially be in closed circuit condition or state. Thus, if energized/activated, the wireless communication module 30 would transmit the value 44 to the reader device 46. If the sensor device 10 were to be subject to an environmental event, the micro-sensor 20 may cause a change in a state of the detection assembly 24 that would result in the detection assembly 24 being in an open circuit condition or state. Thus, if now energized/activated (e.g., after the environmental event), the wireless communication module 30 would instead transmit the value 42 to the reader device 46. Thus, embodiments of the present invention enable the environmental sensor device 10 to monitor sensitive products/objects to which it is attached for potential damage caused by environmental events using electronic indicators (e.g., RFID readers) while the environmental sensor device 10 does not contain or require any internal power source (e.g., a battery). In some embodiments, the detection assembly 24 is configured to be irreversible such that once a change in state of the detection assembly 24 occurs, the detection assembly 24 is prevented from returning to a prior state. For example, if the detection assembly 24 is in a closed circuit state or condition prior to the micro-sensor 20 be activated, and an environmental event causes an activation of the micro-sensor 20 that also causes the detection assembly 24 to transition to an open circuit state or condition, the micro-sensor 20 is configured to be maintained in the open circuit state being unable to return to the closed circuit state. Thus, embodiments of the present disclosure prevent any unauthorized resetting of the environmental sensor device 10.

Embodiments of the environmental sensor device 10 according to the present disclosure may include computer program instructions at any possible technical detail level of integration (e.g., stored in a computer readable storage medium (or media) (e.g., the memory 34) for causing a processor to carry out aspects of the present invention. Computer readable program instructions described herein can be downloaded to respective computing/processing devices (e.g., the wireless communications module 22 and/or the RFID module 30). Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages. In some embodiments, electronic circuitry (e.g., the circuitry 32) including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention. Aspects of the present invention are described herein with reference to illustrations and/or block diagrams of methods and/or apparatus according to embodiments of the invention. It will be understood that each block of the illustrations and/or block diagrams, and combinations of blocks in the illustrations and/or block diagrams, may represent a module, segment, or portion of code, can be implemented by computer readable program instructions. These computer readable program instructions may be provided to a processor or other programmable data processing apparatus to produce a machine, such that the instructions, which execute via the processor, create means for implementing the functions/acts specified in the illustrations and/or block diagram block or blocks. These computer readable program instructions may also be stored in a computer readable storage medium that can direct a computing device, a programmable data processing apparatus, and/or other devices to function in a particular manner, such that the computer readable storage medium having instructions stored therein comprises an article of manufacture including instructions which implement aspects of the function/act specified in the illustrations and/or block diagram block or blocks. The detection assembly 24, the wireless communications module 22, and/or the RFID module 30 may be implemented in any suitable manner using known techniques that may be hardware-based, software-based, or some combination of both. For example, the detection assembly 24, the wireless communications module 22, and/or the RFID module 30 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). As will be appreciated by one skilled in the art, aspects of the present disclosure may be embodied as a system, method or computer program product. Accordingly, aspects of the present disclosure may take the form of a hardware embodiment, a software embodiment (including firmware, resident software, micro-code, etc.) or an embodiment combining software and hardware aspects that may all generally be referred to herein as a “circuit,” “module” or “system.”

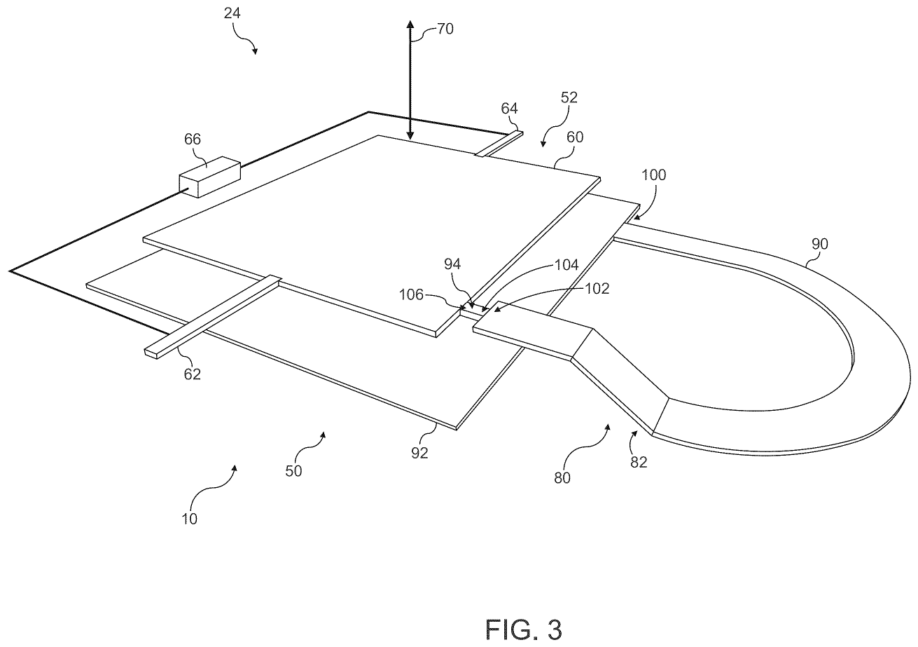

FIG. 3 is a schematic diagram illustrating an exemplary embodiment of the environmental sensor device 10 according to the present disclosure. In the embodiment depicted in FIG. 3, the environmental sensor device 10 is an impact sensor device 50. In FIG. 3, the impact sensor device 50 is depicted in an unarmed state. In exemplary embodiments, the impact sensor device 50 includes the detection assembly 24. In the embodiment illustrated in FIG. 3, the detection assembly 24 includes a response component 52 that is configured to be responsive to one or more environmental stimuli. By way of non-limiting example, the environmental stimulus may be one or more of an acceleration or shock event, vibrations, a temperature event (e.g., a particular temperature level being neared, reached, and/or exceeded at any time or for some time duration), a tilt event, a physical location change, humidity, or light exposure. In the illustrated embodiment of the impact sensor device 50, the response component 52 is a proof mass 60 that is movable in response to an acceleration or shock event exceeding a defined threshold. However, it should be understood that for other types of environmental sensor devices 10 and/or environmental stimuli, the response component 52 may be configured differently.

In FIG. 3, the detection assembly 24 also includes connection elements 62 and 64 coupled to the proof mass 60. The connection elements 62 and 64 are electrically conductive and are electrically coupled to detection circuitry 66 forming at least part of the detection assembly 24. The detection circuitry 66 may be electrically and/or communicatively coupled to the wireless communication module 22 (FIG. 2) such as, by way of non-limiting example, the RFID circuitry 32 (FIG. 2). In exemplary embodiments, at least a portion of the proof mass 60 is electrically conductive such that the proof mass 60 in combination with the connection elements 62 and 64 form a closed electrical circuit of the detection circuitry 66. However, it should be understood that in an alternative embodiment, the connection elements 62 and 64 may extend across the proof mass 60 and be electrically connected to each other without the proof mass 60 being conductive.

In exemplary embodiments, the proof mass 60 is located in a suspended position via one or more flexures, springs, or other types of flexible elements (not shown) such that the proof mass 60 is movable along at least one sensitivity axis 70. Thus, in response to an acceleration or shock event along the sensitivity axis 70, the proof mass 60 deflects or moves in the direction of the sensitivity axis 70 commensurate with the magnitude of the acceleration or shock event. In exemplary embodiments, one or more of the connection elements 62, 64 are fragile or susceptible to breaking in response to the magnitude of the acceleration or shock event exceeding a defined threshold. Thus, in exemplary embodiments, in response to the magnitude of the acceleration or shock event exceeding a defined threshold, at least one of the connection elements 62, 64 breaks and interrupts the electric path between the connection elements 62, 64. Accordingly, in the illustrated embodiment of FIG. 3, the detection circuitry 66 may change from a closed circuit state to an open circuit state. In exemplary embodiments, the proof mass 60 and the connection elements 62, 64 may be formed using standard MEMS, LCD, and/or R2R methods.

In the embodiment illustrated in FIG. 3, the environmental sensor device 10 includes an arming assembly 80 configured to maintain the environmental sensor device 10 in an unarmed state. In other words, for the impact sensor device 50 depicted in FIG. 3, the arming assembly 80 limits or prevents movement of the proof mass 60 to the extent that one or more of the connections elements 62, 64 would break or disconnect the closed circuit of the detection circuitry 66 in response to receipt by the impact sensor device 50 of an acceleration or shock event exceeding a defined threshold. In the embodiment illustrated in FIG. 3, the arming assembly 80 incudes one or more energy harvesting or collecting elements 82. As used herein, “energy collecting elements” are one or more components configured to capture and convert radio frequency signals into an electric current. In exemplary embodiments, the one or more collecting elements 82 are configured to collect or harvest energy from radio waves emitted by a reader device such as, by way of non-limiting example, the reader device 46 (e.g., an RFID reader device). Thus, by way of non-limiting example, the antenna 36 (FIG. 2) may be considered an energy collecting element 82 as the antenna 36 may be used to power the RFID circuitry 32.

In the embodiment illustrated in FIG. 3, the collecting element 82 forming at least part of the arming assembly 80 is a single-turn loop antenna 90. In exemplary embodiments, the arming assembly 80 also includes a ground plane 92 and a retention element 94. The loop antenna 90 is a curved metallic conductor. The loop antenna 90 may be formed by plating or etching a curved metallic conductor onto a nonconductive base material such as paper or plastic. The ground plane 92 is a metallic ground plane which may be in the form of a thin metallic plate or conductive material layer such as, by way of non-limiting example, a metallic or conductive layer formed on a surface of a printed circuit board, paper, or plastic substrate. The retention element 94 is also a metallic or conductive layer. In the embodiment illustrated in FIG. 3, a first end 100 of the loop antenna 90 is electrically connected to the ground plane 92, and a second end 102 of the loop antenna 90 opposite the first end 100 is electrically connected to a first end 104 of the retention element 94. A second end 106 of the retention element 94 opposite the first end 104 is electrically connected to the proof mass 60.

In exemplary embodiments, the retention element 94 is configured having a mechanical strength greater than a mechanical strength of the connection elements 62, 64. Accordingly, in exemplary embodiments, the retention element 94 limits or prevents movement of the proof mass 60 in response to an acceleration or impact event exceeding a defined threshold that would otherwise cause at least one of the connection elements 62, 64 to break. In exemplary embodiments, the retention element 94 is between three times to thirty times thicker in cross-section than the connection elements 62, 64. In exemplary embodiments, the retention element 94 may be formed having a smaller cross-sectional area than the loop antenna 90. The arming assembly 80 may be formed using standard MEMS, LCD, and/or R2R methods.

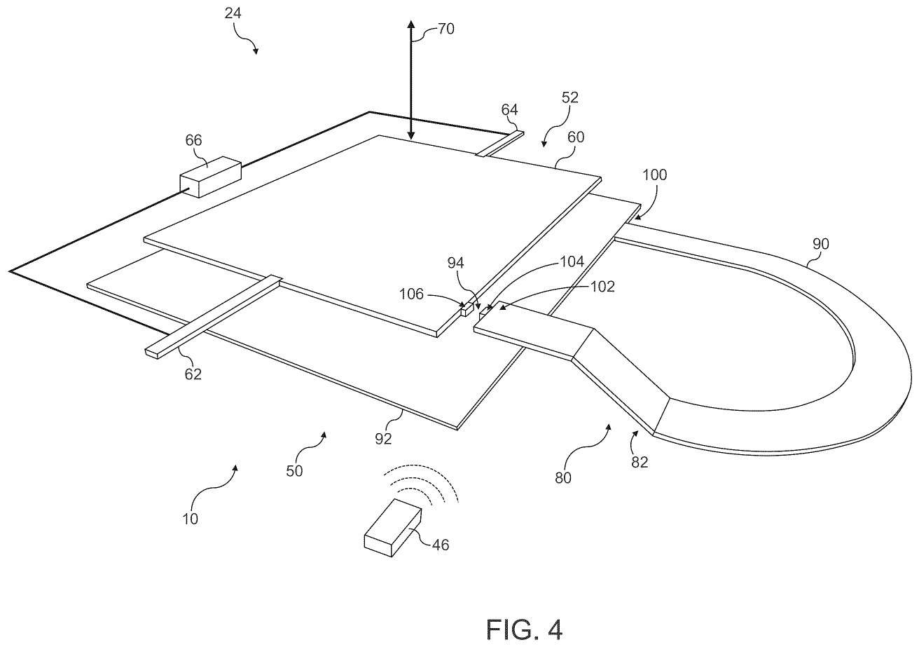

FIG. 4 is a schematic diagram illustrating the exemplary embodiment of the sensor device 10 of FIG. 3 according to the present disclosure in an armed state. In operation, the loop antenna 90 functions as an energy gathering component using radio waves received from a radio wave generating device such as, by of non-limiting example, the reader device 46. Thus, in exemplary embodiments where the reader device 46 is an RFID reader device, the loop antenna 90 receives radio frequency energy from the reader device 46 and functions as an inductive circuit element that resonates with a capacitor formed by the proof mass 60 and the ground plane 92. Based on the radio waves emitted by the reader device 46 and the impingement of those radio waves on the loop antenna 90, a current flows through the loop antenna 90 and the retention element 94. In exemplary embodiments, the inductor-capacitor (LC) resonance causes thermal energy or heat generation in the retention element 94 sufficient to melt the retention element 94 such that the retention element 94 is disconnected from the proof mass 60 and enabling the proof mass 60 to respond to an acceleration or impact event. In other words, the degradation of the retention element 94 results in the proof mass 60 being movable along the sensitivity axis 70 in response to an acceleration or impact event exceeding a defined threshold. In exemplary embodiments, the loop antenna 90, the retention element 94, and/or the ground plane 92 may be selected and/or configured based on frequency characteristics of the radio waves emitted by the reader device 46 such that the radio waves generate a current through the loop antenna 90 and the retention element 94 sufficient to cause a degradation of the retention element 94. Thus, in exemplary embodiments, the retention element 94 functions as a fuse that is responsive to the radio waves emitted by the reader device 46. In FIG. 4, the retention element 94 is depicted in an ablated, melted or fractured state such that the impact sensor device 50 is in an armed state. Accordingly, in response to an acceleration or impact event exceeding a defined threshold, the proof mass 60 is free to move in the direction of the sensitivity axis 70 sufficient to cause one or more of the connection elements 62, 64 to fracture and change the detection circuitry 66 from a closed state to an open state.

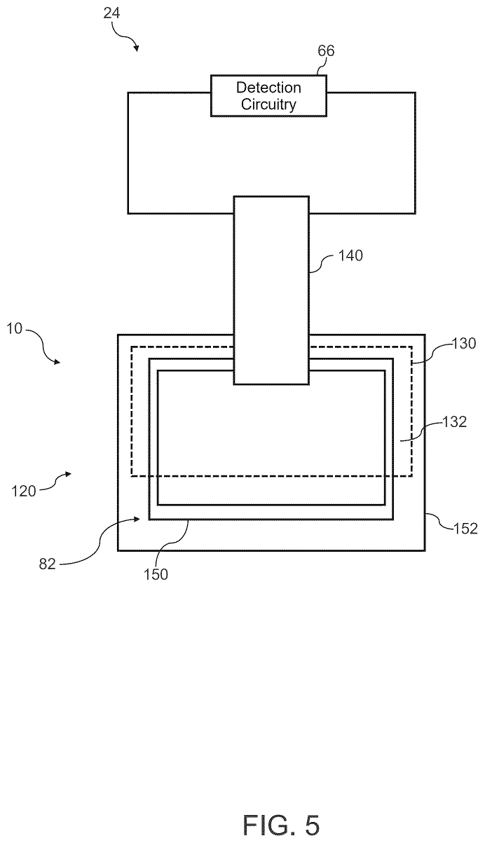

FIG. 5 is a schematic diagram illustrating an exemplary embodiment of the sensor device 10 according to the present disclosure. In the embodiment depicted in FIG. 5, the sensor device 10 is a temperature sensor device 120. In FIG. 5, the temperature sensor device 120 includes a reservoir 130 containing a substance 132 that is responsive to a temperature exceeding a defined threshold. In exemplary embodiments, the substance 132 may be a wax or ionic substance or compound in solid form that melts or liquifies in response to being exposed to a temperature level exceeding a defined threshold. The reservoir 130 may be in the form of a paper material having the substance embedded therein or thereon. The reservoir 130 may also be a container for holding the substance 132 therein such as, by way of non-limiting example, a walled receptacle. The temperature sensor device 120 also includes an indicator element 140 that is positioned with respect to the reservoir 130 such that in response to a temperature event exceeding a defined threshold, the substance 132 melts or liquifies and is absorbed by the indicator element 140. The indicator element 140 may be configured to provide a visual indication of activation of the temperature sensor device 120 such that, by way of non-limiting example, the substance 132 may be a particular color or become a particular color in response to a temperature event exceeding a defined threshold. The absorption and/or migration of the substance 132 into and/or along some length of the indicator element 140 may provide a visual indication of activation of the temperature sensor device 120. In addition or alternatively, the indicator element 140 may be coupled to the detection circuitry 66 and the substance 132 may be an ionic substance such that the presence and/or migration of the ionic substance in and/or along some length of the indicator element 140 may close an electric circuit (e.g., changing the detection circuitry 66 from an open circuit state to a closed circuit state).

In the embodiment illustrated in FIG. 5, the temperature sensor device 120 includes the collecting element 82 in the form of a loop antenna 150 disposed or formed on a substrate 152. At least a portion of the loop antenna 150 is disposed between the indicator element 140 and the substance 132. In operation, at least a portion of the loop antenna 150 functions as a dam or blocking element that limits or blocks the flow of the substance 132 from reaching or contacting the indicator element 140 in an unarmed state of the temperature sensor device 120. Thus, in exemplary embodiments, at least a portion of the loop antenna 150 maintains the temperature sensor device 120 in an unarmed state such that, in response to being subjected to a temperature event exceeding a defined threshold that would otherwise cause the substance 132 to melt or liquify, the substance 132 is prevented from contacting the indicator element 140. In exemplary embodiments, the substrate 152 may be a nonconductive plastic sheet or layer of material.

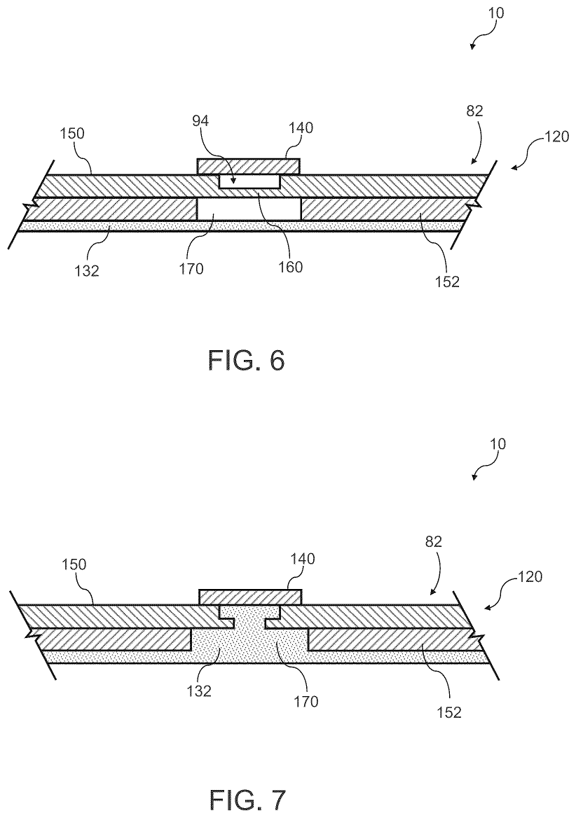

Referring now also to FIGS. 6 and 7, FIG. 6 is a schematic, enlarged, section view of a portion of the of the temperature sensor device 120 of FIG. 5 in an unarmed state, and FIG. 7 is a schematic, enlarged, section view of a portion of the of the temperature sensor device 120 of FIG. 5 in an armed state. As best depicted in FIG. 6, the retention element 94 is formed as part of the loop antenna 150. In the embodiment illustrated in FIGS. 6 and 7, the retention element 94 includes a portion 160 of the loop antenna 150 that functions as a fuse portion of the loop antenna 150. The portion 160 may be a narrowed or necked-down area in cross-section of the loop antenna 150 such that a sufficient current flowing through the loop antenna 150 causes a sufficient amount of heat to degrade, melt or ablate the portion 160. In exemplary embodiments, the substrate 152 includes an opening, void area, or passageway 170 located proximate the portion 160 and between the substance 132 and the portion 160. In exemplary embodiments, in response to the temperature sensor device 120 being subjected to a temperature event exceeding a defined threshold that would otherwise cause the substance 132 to melt or liquify, the substance 132 may enter the passageway 170 but further flow of the substance 132 is limited, blocked or prevented from reaching or contacting the indicator element 140 by the portion 160.

As best depicted in FIG. 7, in response to radio waves emitted by a radio wave-emitting device such as, by way of non-limiting example, the reader device 46 (e.g., an RFID reader device) and impinging on the loop antenna 150, a current is generated in the loop antenna 150 and generates heat in the loop antenna 150. In exemplary embodiments, the loop antenna 150 and/or the portion 160 may be selected and/or configured based on frequency characteristics of the radio waves emitted by the reader device 46 such that the radio waves generate a current through the loop antenna 150 and the portion 160 sufficient to cause a degradation of the portion 160. As depicted in FIG. 7, the degradation, melting or ablation of at least a portion of the portion 160 enables the passageway 170 to be in fluid communication with the indicator element 140 and enables the substance 132 to flow through the passageway 170 and contact the indicator element 140 in response to a temperature event exceeding a defined threshold that would cause the substance 132 to melt or liquify. In FIGS. 5-7, a ground plane such as, by way of non-limiting example, the ground plane 92 (FIGS. 3 and 4) is omitted from view for ease of description and illustration. However, it should be understood that a conductive layer or ground plane may be located in the layered arrangement of the temperature sensor device 120 at one or more different locations to create an inductor-capacitor (LC) resonance with respect to the loop antenna 150 to cause heat generation sufficient to melt or ablate at least a portion of the portion 160. By way of non-limiting example, a ground plane may be located on the substrate 152 spaced apart from the loop antenna 150 (e.g., on an opposite side of the substrate 152 from the loop antenna 150) or may be a separate conductive layer located above or below and spaced apart from the loop antenna 150 in a layered arrangement of the temperature sensor device 120.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. An environmental sensor device, comprising:
a detection assembly comprising at least one response component that is responsive to receipt by the detection assembly of an environmental stimuli exceeding a threshold; and
an arming assembly configured to maintain the detection assembly in an unarmed state, wherein the arming assembly comprises:
a collecting element; and
a retention element coupled to the collecting element, the retention element positioned to prevent the at least one response component from being responsive to the environmental stimuli, and wherein the collecting element is configured to collect energy that causes an ablation of the retention element to place the detection assembly in an armed state.

2. The environmental sensor device of claim 1, wherein the collecting element is configured to collect the energy from radio waves.

3. The environmental sensor device of claim 1, wherein the collecting element comprises at least one antenna.

4. The environmental sensor device of claim 1, wherein the retention element is further coupled to the at least one response component.

5. The environmental sensor device of claim 1, wherein the at least one response component comprises a substance configured to liquify in response to the environmental stimuli.

6. The environmental sensor device of claim 5, and wherein the retention element is positioned to limit movement of a liquified state of the substance.

7. The environmental sensor device of claim 1, further comprising a wireless communication module configured to output an activation status of the detection assembly.

8. An environmental sensor device, comprising:
a detection assembly comprising at least one response component that is responsive to receipt by the detection assembly of an environmental stimuli exceeding a threshold;
one or more antennas; and
a retention element coupled to at least one antenna of the one or more antennas, the retention element positioned to prevent the at least one response component from being responsive to the environmental stimuli, and wherein the at least one antenna is configured to collect radio wave energy that causes an ablation of the retention element to enable the at least one response component to be responsive to the environmental stimuli.

9. The environmental sensor device of claim 8, further comprising a wireless communication module configured to output an activation status of the detection assembly.

10. The environmental sensor device of claim 9, wherein the at least one antenna comprises a first antenna, and wherein the one or more antennas comprises a second antenna, the second antenna configured to power the wireless communication module based on the receipt of radio waves from a reader device.

11. The environmental sensor device of claim 8, wherein the at least one response component comprises a proof mass.

12. The environmental sensor device of claim 11, wherein the retention element is coupled to the proof mass.

13. The environmental sensor device of claim 11, further comprising a ground plane disposed spaced apart from the proof mass.

14. The environmental sensor device of claim 8, wherein the at least one response component comprises a substance configured to liquify in response to the environmental stimuli, and wherein the retention element is positioned to limit movement of a liquified state of the substance.

15. An environmental sensor device, comprising:
a detection assembly comprising at least one response component that is responsive to receipt by the detection assembly of an environmental stimuli exceeding a threshold; and
an arming assembly positioned to maintain the detection assembly in an unarmed state, wherein the arming assembly comprises:
a retention element positioned to prevent the response component from being responsive to the environmental stimuli; and
a collecting element electrically coupled to the retention element, wherein responsive to radio waves impinging the collecting element, a current flows through the retention element and generates thermal energy in the retention element, and wherein the thermal energy causes an ablation of the retention element and places the detection assembly in an armed state.

16. The environmental sensor device of claim 15, wherein the retention element is coupled to the at least one response component.

17. The environmental sensor device of claim 15, wherein the at least one response component comprises at least one of:
a proof mass that moves in response to the environmental stimuli; or
a substance that liquifies in response to the environmental stimuli.

18. The environmental sensor device of claim 15, further comprising a wireless communication module configured to output an activation status of the detection assembly.

19. The environmental sensor device of claim 15, wherein the collecting element comprises an antenna, and wherein the retention element comprises at least a portion of the antenna.

20. The environmental sensor device of claim 15, wherein the detection assembly forms at least part of at least one of an impact sensor device or a temperature sensor device.
